(19) United States
(12) Patent Application Publication
(10) Pub. No.: US 2019/0005228 A1
(43) Pub. Date: Jan. 3, 2019

(54) TRUSTED AND UNTRUSTED CODE EXECUTION IN A WORKFLOW

(71) Applicant: Microsoft Technology Licensing, LLC, Redmond, WA (US)

(72) Inventors: Vinay Singh, Redmond, WA (US); Ilya Grebnov, Kirkland, WA (US); Javed Akhter, Sammamish, WA (US); Charles Lamanna, Bellevue, WA (US); Rama K. Rayudu, Redmond, WA (US); Jonathan Fancey, Bellevue, WA (US)

(21) Appl. No.: 15/638,328

(22) Filed: Jun. 29, 2017

(51) Int. Cl. G06F 21/53; G06F 9/44; G06F 9/50

(52) U.S. Cl. CPC G06F 21/53; G06F 9/5077; G06F 8/34

(57) ABSTRACT

Methods, systems, and computer program products are described herein for implementing a workflow development system that enables users to incorporate custom functionality within a workflow. During runtime execution of the workflow, the custom functionality (e.g., custom code) is executed in a sandboxed environment, thereby ensuring that the custom code consumes only a limited amount of computing resources (e.g., processing power, memory, storage, etc.) that may be shared with other processes. The foregoing may be achieved without requiring the user to be aware that a sandboxed environment is being utilized. Instead, the user simply needs to select and associate a custom function with a particular workflow step, and the workflow development system manages the interactions with the sandboxed environment without any further user involvement.

### BACKGROUND

A software application is a computer program used by end users to perform various functions. Internal to an organization, software applications are frequently developed when available off-the-shelf software does not completely address the desired functionality. Many applications are interactive, having a graphical user interface (GUI) via which users can input data, submit data queries, perform operations, and view results.

Certain users (e.g., organizational users) tend to depend on information technology (IT) personnel to code their applications due to application complexity, and the programming expertise required. For example, merely designing an application to retrieve data from a remote source (e.g., a cloud service) is difficult, typically requiring the involvement of an experienced software developer.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are described herein for implementing a workflow development system that enables users to incorporate custom functionality within a workflow. During runtime execution of the workflow, the custom functionality (e.g., custom code) is executed in a sandboxed environment, thereby ensuring that the custom code consumes only a limited amount of computing resources (e.g., processing power, memory, storage, etc.) that may be shared with other processes. The foregoing may be achieved without requiring the user to be aware that a sandboxed environment is being utilized. Instead, the user simply needs to select and associate a custom function with a particular workflow step, and the workflow development system manages the interactions with the sandboxed environment without any further user involvement.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 is a block diagram of a system for developing and executing a workflow in accordance with an embodiment.

FIG. 2 is a block diagram of a workflow development system, according to an example embodiment.

FIG. 3 depicts a flowchart of a process for development of workflows, according to an example embodiment.

FIG. 4 is a block diagram of a workflow designer application, according to an example embodiment.

FIG. 5 is a block diagram of a display screen showing a browser window displaying an exemplary workflow, according to an example embodiment.

FIGS. 6-9 show views of an exemplary workflow in various phases of development using a workflow designer GUI, according to example embodiments.

FIG. 10 is a block diagram of a system for executing a workflow in a runtime environment, according to an example embodiment.

FIG. 11 depicts a flowchart of a process for executing a user application that includes one or more workflows in a runtime environment, according to an example embodiment.

FIG. 12 depicts an example graphical user interface (GUI) screen of a workflow development system that can be used to select and associate a function comprising untrusted code with a workflow step of a workflow in accordance with an embodiment.

FIG. 13 depicts a flowchart of a method for developing and executing workflow step(s) that comprise untrusted code in accordance with an embodiment.

FIG. 14 is a block diagram of an exemplary user device in which embodiments may be implemented.

FIG. 15 is a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments for Development of Workflows Including Untrusted Code

### A. Example Workflow Development System Embodiments

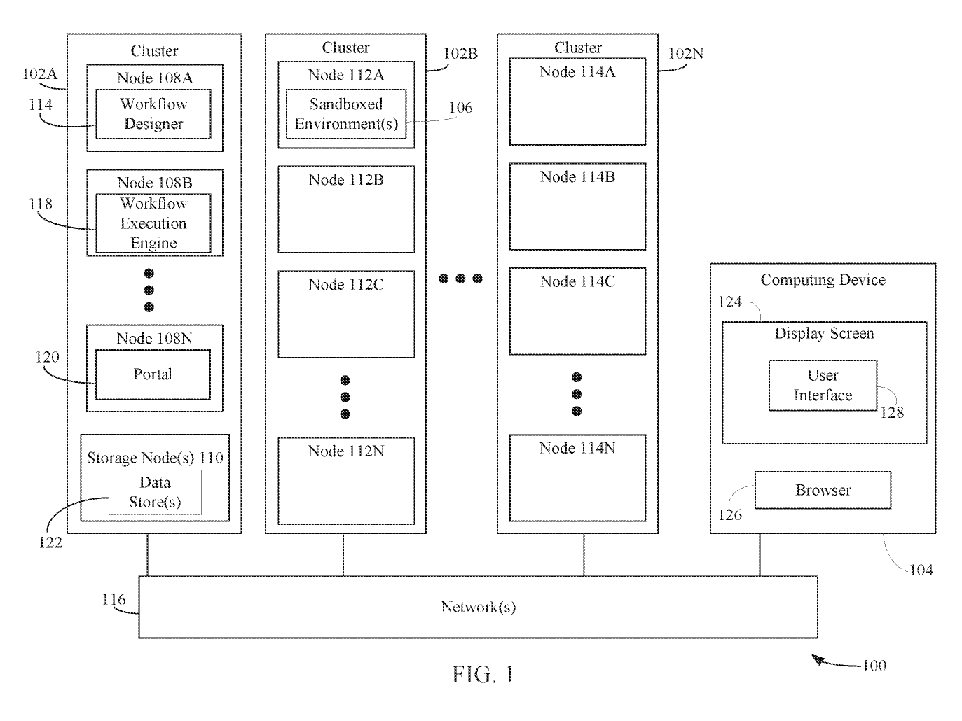

FIG. 1 shows a block diagram of an example system 100 for running trusted and untrusted code in a workflow, according to an example embodiment. As shown in FIG. 1, system 100 includes a plurality of clusters 102A, 102B and 102N and a computing device 104. Each of clusters 102A, 102B and 102N and computing device 104 may be communicatively connected to each other via one or more network(s) 116. Network(s) 116 may comprise one or more networks such as local area networks (LANs), wide area networks (WANs), enterprise networks, the Internet, etc., and may include one or more of wired and/or wireless portions.

Clusters 102A, 102B and 102N may form a network-accessible server set. Each of clusters 102A, 102B and 102N may comprise a group of one or more nodes and/or a group of one or more storage nodes. For example, as shown in FIG. 1, cluster 102A includes nodes 108A-108N and one or more storage nodes 110, cluster 102B includes nodes 112A-112N, and cluster 102N includes nodes 114A-114N. Each of nodes 108A-108N, 112A-112N and/or 114A-114N are accessible via network(s) 116 (e.g., in a “cloud-based” embodiment) to build, deploy, and manage applications and services. Each of storage node(s) 110 comprise a plurality of physical storage disks that are accessible via network(s) 116 and are configured to store data associated with the applications and services managed by nodes 108A-108N, 112A-112N, and/or 114A-114N.

In an embodiment, one or more of clusters 102A, 102B and 102N may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 102A, 102B and 102N may be a datacenter in a distributed collection of datacenters.

Each of node(s) 108A-108N, 112A-112N and 114A-114N may be configured to execute one or more software applications (or “applications”) and/or manage hardware resources (e.g., processors, memory, etc.), which may be utilized by users (e.g., customers) of the network-accessible server set. Node(s) 108A-108N, 112A-112N and 114A-114N may also be configured for specific uses. For example, as shown in FIG. 1, node 108A is configured to execute a workflow designer 114, node 108B is configured to execute a workflow execution engine 118, node 108N is configured to execute a portal 120 and node 112A is configured to execute one or more sandboxed environments 106.

In accordance with an embodiment, each of node 108A, node 108B, and node 112A are configured to be a multi-tenant machine. In accordance with such an embodiment, node 108A enables one or more tenants to utilize workflow designer 114 and other tenant(s) to utilize other one or more applications (not shown) executing on node 108A, node 108B enables tenant(s) to utilize workflow execution engine 118 and other tenant(s) to utilize other application(s) (not shown) executing on node 108B, and node 112A enables tenant(s) to utilize sandboxed environment 106 and other tenant(s) to utilize other application(s) (not shown) executing on node 112A. A tenant may comprise a group of one or more users who share a common access with specific privileges to one or more of workflow designer 114, workflow execution engine 118, sandboxed environment 106 and/or other application(s) executing on a particular node. In accordance with an embodiment, each of node 108A, node 108B and/or node 112A is configured to be a multi-tenant machine by being configured to execute a multi-tenant virtual machine, each of which is being configured to respectively execute workflow designer 114, workflow execution engine 118, sandboxed environment 106, and/or other application(s).

It is noted that each of workflow designer 114, workflow execution engine 118, and/or portal 120 may be executing on the same node or same cluster or, alternatively, on a different node or different cluster. It is also noted that sandboxed environment(s) 106 may be executing on a different node within the same cluster on which workflow designer 114, workflow execution engine 118 and/or portal 120 is executing. It is further noted that cluster 102B and/or cluster 102N may also include storage node(s) 110.

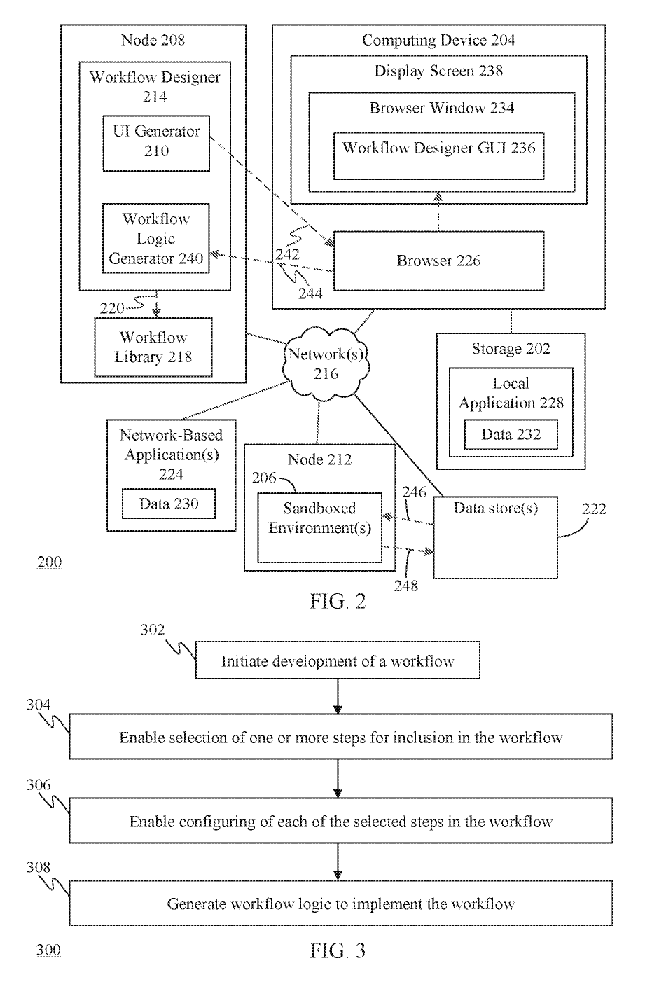

Workflow designer 114 is configured to enable a user to design one or more workflows, each comprising one or more workflow steps. For example, workflow designer 114 may enable a user to select and configure workflow steps into a workflow using a graphical user interface (GUI). Additional details regarding the functionality of workflow designer 114 are described below with reference to FIGS. 2-9.

One or more of the workflow steps of the workflow may utilize trusted code, which is code provided by a trusted provider, e.g., by a publisher of workflow designer 114 or other trusted entity. One or more other workflows steps of the workflow may utilize custom functionality (e.g., custom code) written and/or provided by a user developing a workflow or other third parties. An example of such custom functionality includes, but is not limited to, an Extensible Stylesheet Language Transformation (XSLT)-based function (also referred to as an XSLT map). XSLT-based functions may be configured to transform an XML document into a form suitable for subsequent workflow steps. For example, an XSLT-based function may perform string manipulation, arithmetic operations, enrichment of data included in the XML document based on data other data sources, or any other type of functionality. However, this is merely one example of custom functionality. As used herein, the term “custom functionality” is used to refer to any user-provided and/or user-written code that may be associated with a workflow step and that is not a predefined part of a workflow step made available via workflow designer 114 by the publisher thereof.

A user may be enabled to associate custom functionality with an account associated with the user. A user may be given access to his or her account by logging into a portal 120. Upon logging into portal 120, a user may store (e.g., upload) a custom-written function that performs the custom functionality to one or more data stores 122 associated with the user's account. A user, using workflow designer 114, may be enabled to select and associate the function stored in data store(s) 122 to a particular workflow step of any number of workflows being designed.

A user may access portal 120 via computing device 104. As shown in FIG. 1, computing device 104 includes a display screen 124 and a browser 126. A user may access portal 120 by interacting with an application at computing device 104 capable of accessing portal 120. For example, the user may use browser 126 to traverse a network address (e.g., a uniform resource locator) to portal 120, which invokes a user interface 128 (e.g., a web page) in a browser window rendered on computing device 104. By interacting with the user interface, the user may utilize portal 120 to upload custom-written functions to his or her account. Computing device 104 may be any type of stationary or mobile computing device, including a mobile computer or mobile computing device (e.g., a Microsoft® Surface® device, a laptop computer, a notebook computer, a tablet computer such as an Apple iPad™, a netbook, etc.), a wearable computing device (e.g., a head-mounted device including smart glasses such as Google® Glass™, etc.), or a stationary computing device such as a desktop computer or PC (personal computer).

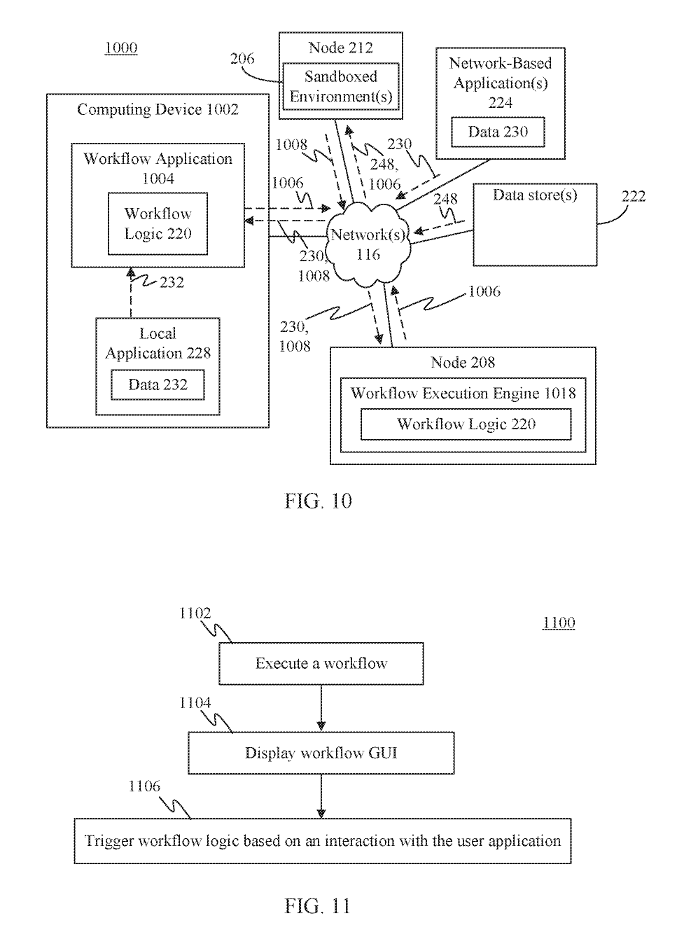

While incorporating custom code into a workflow advantageously enables a user to add custom functionality to the workflow, when the workflow executes in a multi-tenant environment, there is a risk that the custom code may inadvertently access data associated with another tenant, consume computing resources (e.g., processing power, memory, storage, etc.) that could be used by trusted code and/or other tenants, etc. For these reasons, custom code is also referred to as untrusted code. To address these issues, such untrusted code may be compiled by a first sandboxed environment of sandboxed environment(s) and/or executed in a second sandboxed environment of sandboxed environment(s) 106. For example, upon being stored in data store(s) 122, a first sandboxed environment of sandboxed environment(s) 106 may pre-compile the untrusted code and store the pre-compiled version in data store(s) 122. Upon execution of the workflow, the pre-compiled untrusted code may be loaded from data store(s) 122 and executed in a second sandboxed environment of sandboxed environment(s) 106, whereas the workflow steps not incorporating untrusted code may be executed in a non-sandboxed environment by workflow execution engine 118. A non-sandboxed environment may be a node that does not provide some or all of the isolation and/or computing resource limitation features described below with respect to sandboxed environment(s) 106. For example, the pre-compiled untrusted code may be executed on the same node on which workflow execution engine 118 is executing. Additional details regarding workflow execution engine 118 are described below with reference to FIG. 10.

As shown in FIG. 1, sandboxed environment(s) 106 are executing on a different node and cluster than workflow designer 114 and workflow execution engine 118. This advantageously isolates the compilation and execution of untrusted code from processes (e.g., workflow execution) running on other node(s) and/or cluster(s), thereby preventing the untrusted code from adversely impacting those processes (e.g., by consuming resources shared by such processes and/or causing technical issues, such as system crashes, etc.). Moreover, in a scenario where multiple tenants are executing untrusted code in sandboxed environments(s) 106, sandboxed environment(s) 106 may restrict or limit access to one or more computing resources that are to be utilized during execution of the untrusted code. The resources that are restricted may include, but are not limited to, processing, memory access, storage allocation, and/or shared components of the operating system executing on the machine on which sandboxed environment(s) 122 are executing (e.g., node 112A). Such shared components include, but are not limited to, the operating system's registry, graphics subsystems, security policies (such as, but not limited to, the Local Security Authority Subsystem Server (LSASS) provided by Microsoft Windows operating systems), etc. By restricting or limiting access to such computing resources, sandboxed environment(s) 106 isolate the untrusted code from one another during compilation and/or execution so that they do not interfere with each other and/or other processes executing on node 112A. In accordance with an embodiment, sandboxed environment(s) 106 may be provided via a service such as Azure Functions developed and published by Microsoft Corporation of Redmond. It is noted that in certain embodiments, sandboxed environment(s) 106 may be included on the same node on which workflow execution engine 114 and/or workflow execution 118 so long as the node includes sufficient isolation and/or computing resource limitation mechanisms as described above.

Development of workflows may be enabled in various ways in embodiments. For instance, FIG. 2 is a block diagram of a workflow development system 200, according to an example embodiment. As shown in FIG. 2, system 200 includes a computing device 204, storage 202, one or more network-based applications 224, a node 208, a node 212, and data store(s) 222. Computing device 204, node 208, node 212, and data store(s) 222 may be examples of computing device 104, node 108A, node 112A, and data store(s) 122, as shown in FIG. 1. Node 208 includes a workflow designer 214 and a workflow library 218 (e.g., in storage). Workflow designer 214 is an example of workflow designer 114, as shown in FIG. 1. Computing device 204 includes a display screen 238 and a browser 226. Storage 202 stores a local application 228. System 200 is described as follows.

Local application 228 in storage 202 is an example of an application accessible by computing device 204 without communicating over a network. Local application 228 may be configured to perform data processing and/or data hosting operations when executed by a processor of computing device 204, and may provide data 232 to workflows developed using workflow designer 214 when such workflows are executed at runtime, or receive data 232 therefrom. Local application 228 may be any type of local application or service, such as a database application (e.g., QuickBooks®, a Microsoft® Excel® spreadsheet), an e-mail application (e.g., Microsoft® Outlook®), a productivity application (e.g., Microsoft® Word®, Microsoft® PowerPoint®, etc.), or another type of application. Although FIG. 2 shows a single local application, any number of local applications may be present at computing device 204, including numbers in the tens, hundreds, or greater numbers.

Network-based application(s) 224 are examples of network-based applications, which in some instances may be referred to as “cloud” applications or services (e.g., network-based application(s) 224 may be executing on one nodes 108A-108N, nodes 112A-112N or nodes 114A-114N shown in FIG. 1). Network-based application(s) 224 are accessible by computing device 204 over network(s) 216 (which is an example of network(s) 116, as shown in FIG. 1), may be configured to perform data processing and/or data hosting operations, and may provide data 230 to workflows created using workflow designer 214 when such workflows are executed at runtime, or receive data 230 therefrom. Network-based application(s) 224 may each be any type of network-accessible applications or services, such as database applications, social networking applications, messaging applications, financial services applications, news applications, search applications, productivity applications, cloud storage applications, file hosting applications, etc. Examples of such applications include a network-accessible SQL (structured query language) database, Salesforce.com™, Facebook®, Twitter®, Instagram®, Yammer®, LinkedIn®, Yahoo! ® Finance, The New York Times® (at www.nytimes.com), Google search, Microsoft® Bing, Google Docs™, Microsoft® Office 365, Dropbox™, etc. It is noted that any number of network-based applications may be accessible over network 216, including numbers in the tens, hundreds, thousands, or greater numbers.

Note that data 230 and data 232 may each include any type of data, including messages, notifications, calculated data, retrieved data, structured data, unstructured data, and/or any other type of information produced, requested or usable by a workflow.

Node 212 includes sandboxed environment(s) 206. Sandboxed environment(s) 206 are an example of sandboxed environment(s) 106, as shown in FIG. 1. Sandboxed environments(s) 206 may be configured to pre-compile untrusted code 246 stored in data store(s) 222. As described above with reference to FIG. 1, untrusted code 246 may be uploaded to data store(s) 222 via portal 120. Upon untrusted code 246 being stored in data store(s) 222, untrusted code 246 may be provided to sandboxed environment(s) 206. Sandboxed environment(s) 206 may pre-compile untrusted code 246 to generate pre-compiled untrusted code 248 and may store pre-compiled untrusted code 248 in data store(s) 222. Pre-compiled untrusted code 248 may be incorporated into any number of workflows. By pre-compiling untrusted code 248 before execution of the workflow, the overhead of compiling untrusted code 246 each time a workflow is executed is advantageously reduced.

Computing device 204, node 208 and node 212 may each include at least one wired or wireless network interface that enables communications with each other and with network-based application(s) 224 and data store(s) 222 over network(s) 216. Examples of such a network interface include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

Workflow designer 214 is configured to be operated/interacted with to create applications in the form of workflows. For instance, a developer may access workflow designer 214 by interacting with an application at computing device 204 that is capable of accessing a network-based application, such as browser 226. The developer may use browser 226 to traverse a network address (e.g., a uniform resource locator) to workflow designer 214, which invokes a workflow designer GUI 236 (e.g., a web page) in a browser window 234. The developer is enabled to interact with workflow designer GUI 236 to develop a workflow.

As shown in FIG. 2, workflow designer 214 includes a UI generator 210 and a workflow logic generator 240. UI generator 210 is configured to transmit workflow GUI information 242 (e.g., one or more web pages, image content, etc.) to browser 226 to be displayed as workflow designer GUI 236 within browser window 234 in display screen 238. Workflow designer GUI 236 may be interacted with by a developer to select and configure workflow steps into a workflow. For example, the developer may insert and sequence a plurality of workflow steps in workflow designer GUI 236, with one or more of the steps being associated with a local or network-based application. The developer may further insert and sequence one or more workflow steps that enable a user to select pre-compiled untrusted code 248 (e.g., a custom-written XLST-based transformation function or any of a wide variety of other user-provided functions) to be executed during execution of those workflow step(s). Browser 226 stores the selected workflow steps, corresponding configuration information, and workflow step sequence information as constructed workflow information 244. Constructed workflow information 224 is transmitted to workflow logic generator 240 at node 208. Workflow logic generator 240 generates workflow logic 220 based on the assembled workflow represented by constructed workflow information 244. The workflow represented by workflow logic 220 may subsequently be invoked for execution by an end user.

During runtime execution of the workflow, workflow logic 220 may invoke operation of one or more local or network-based applications associated with the workflow steps of workflow logic 220. Each workflow step may receive input data from or transmit output data to the one or more local or network-based applications. Such input or output data may include, for example, data 232 received from or sent to local application 228, data 230 received from or sent to network-based application(s) 224, data received from or sent to another application, and/or data received from or sent to another workflow step of workflow logic 220.

During runtime execution of the workflow, workflow logic 220 may also invoke operation of sandboxed environment(s) 206 for workflow step(s) for which pre-compiled untrusted code 246 is selected and associated therewith. For example, workflow logic 220 may provide output data provided by a previous workflow step to sandboxed environment(s) 206 and may cause sandboxed environment(s) 206 to load and execute pre-compiled untrusted code 248 using the output data as inputs. Any output data resulting from the execution of pre-compiled untrusted code 248 may be used as input data for subsequent workflow steps during execution thereof.

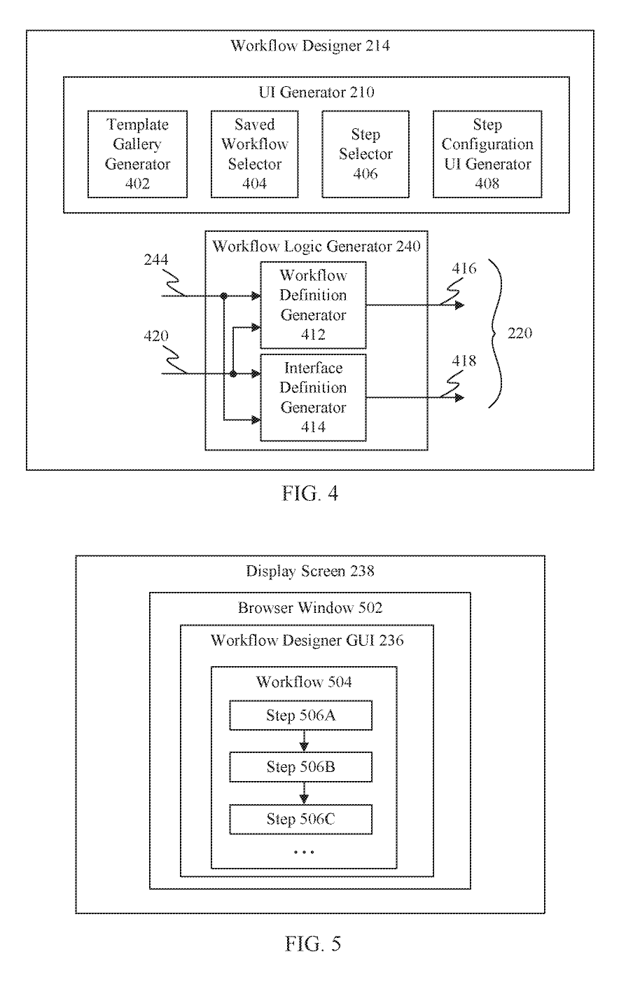

Workflow designer 214 may operate in various ways, to enable development of a workflow. For instance, in embodiments, workflow designer 214 may operate in accordance with flowchart 300 of FIG. 3. In particular, flowchart 300 depicts a process for development of workflows, according to an example embodiment. Flowchart 300 and workflow designer 214 are described as follows with respect to FIGS. 4 and 5. FIG. 4 is a block diagram of workflow designer 214, according to an example embodiment. As shown in FIG. 4, workflow designer 214 includes UI generator 210 and workflow logic generator 240. UI generator 210 includes a template gallery generator 402, a saved workflow selector 404, a step selector 460, and a step configuration UI generator 408. Workflow logic generator 240 includes a workflow definition generator 412 and an interface definition generator 414. FIG. 5 is a block diagram of display screen 238, illustrating an example of workflow designer GUI 236 displayed in browser window 502 on display screen 238, according to an example embodiment.

Flowchart 300 of FIG. 3 begins with step 302. In step 302, development of a workflow is initiated. For example, in an embodiment, workflow designer 214 may be invoked by a developer interacting with browser 226 at computing device 204. The developer may traverse a link or other network address directed to workflow designer 214 at node 208, to invoke workflow designer 214, causing workflow designer 214 to provide workflow GUI information 242 (e.g., one or more web pages, image content, etc.) to browser 226 to be displayed as workflow designer GUI 236 in display screen 238 in browser window 234. Once invoked, the developer may open an existing workflow for further development, or may begin developing a new workflow.

In one example, a displayed page of workflow designer GUI 236 may display a template gallery generated by template gallery generator 402. The template gallery may include a plurality of selectable workflow templates, each of which includes one or more pre-selected workflow steps that are suitable for further configuration by a developer. The workflow templates may be stored in workflow library 218, and accessed for display by workflow designer GUI 236. The developer may select one of the workflow templates for inclusion in their workflow, and may proceed with configuring the contents of the workflow template, and/or may add additional workflow steps to the workflow steps of the workflow template to generate a more complex workflow.

For instance, in the example of FIG. 5, steps 506A and 506B may have been included in a workflow template placed in workflow 504, and step 506C may have been subsequently added (e.g., via selection from a menu or other list of workflow steps).

In another example, saved workflow selector 404 may enable the developer to select an existing, saved workflow to be opened for further editing in a displayed page of workflow designer GUI 236. The saved workflows may be stored in workflow library 218 or elsewhere. For example, saved workflow selector 404 may display a list of saved workflows, may enable navigation to a saved workflow, and/or may provide another mechanism for selecting a saved workflow for editing. The developer may then proceed with further configuring the contents of the workflow, adding workflow steps, modifying workflow steps, removing workflow steps, or the like.

In yet another example, a displayed page of workflow designer GUI 236 may provide a blank window, area or canvas to which one or more developer-selected workflow steps may be added, ordered and configured. Such blank window, area or canvas may be generated by UI generator 210 automatically or in response to some developer input or interaction.

In step 304, selection of one or more steps for inclusion in the workflow is enabled. When a developer is editing a workflow, step selector 406 may enable the developer to select workflow steps for inclusion in the workflow, and to order the steps. The workflow steps may be accessed by step selector 406 in workflow library 218. For instance, step selector 406 may display a menu of workflow steps, a scrollable and/or searchable list of available workflow steps, or may provide the workflow steps in another manner, and may enable the developer to select any number of workflow steps from the list for inclusion in the workflow.

In one example, step selector 406 may enable a developer to select a step that is associated with a local application, such as Microsoft® Outlook®, a network-based application, such as Facebook®, or a service that provides a sandboxed environment, such as Azure Functions developed and published by Microsoft Corporation of Redmond. Step selector 406 enables the steps to be chained together in a sequence, optionally with conditional steps, for inclusion in workflow logic 220.

In step 306, each of the selected steps in the workflow is enabled to be configured. In an embodiment, step configuration UI generator 408 enables configuration of each workflow step in a workflow. Step configuration UI generator 408 accesses each selected workflow step in workflow library 218 to determine the configuration of the workflow step, including all of its input parameters and any other selections or information that a developer needs to provide to the workflow step to configure it. For example, step configuration UI generator 408 may generate a UI that enables the developer to type, navigate to, use a pull-down menu, or otherwise enter input data into a text input box or other data entry element to configure (e.g., specify an input parameter of) a workflow step. The developer may configure an output parameter of a prior step to be input data for a workflow step. Step configuration UI generator 408 may enable data or other objects to be copied and pasted, dragged and dropped, or otherwise entered from elsewhere into data entry elements of a workflow step.

In step 308, workflow logic to implement the workflow is generated. In an embodiment, workflow logic generator 240 is configured to package and generate workflow logic 220 based on constructed workflow information 244 when the developer indicates the workflow is finished, such as when the developer interacts with workflow designer GUI 236 to save the workflow. As shown in FIG. 4, workflow logic generator 240 receives constructed workflow information 244. Constructed workflow information 244 indicates which workflow steps have been inserted into the workflow, their input parameter values, and their sequencing. Workflow logic generator 240 also receives selected workflow logic 420, which is the workflow logic for each workflow step of the workflow as indicated in constructed workflow information 244. In one example, workflow logic generator 240 retrieves workflow logic from workflow library 218 for each workflow step indicated in constructed workflow information 244, to receive selected workflow logic 420. Workflow logic generator 240 generates workflow logic 220 for the workflow based on constructed workflow information 244 and selected workflow logic 420. For example, workflow logic generator 240 may generate workflow logic 220 in the form of an executable file, a zip file, or other form, which may be executed in a standalone fashion, may be executed in a browser, or may be executed in another manner, depending on the particular type of workflow being generated.

With reference to FIG. 4, workflow logic generator 240 may generate workflow logic 220 to include at least two components (e.g., files): workflow definition information 416 and interface definition information 418. Workflow definition information 416 includes information that defines the sequence and operation of the workflow of workflow logic (e.g., lists the workflow step operations and their ordering/sequencing) and includes the parameter values for the workflow. For example, workflow definition information 416 may be generated to contain information in the format of a JSON (JavaScript object notation) file or in another form. Interface definition information 418 includes information that defines the interfaces/parameters (e.g., inputs and outputs) of the workflow steps of the workflow. For example, interface definition information 418 may be generated to contain information in the format of a Swagger (a specification for REST (representational state transfer) web services) file or in another form. For instance, each workflow step may be represented in workflow library 218 as API (application programming interface) metadata in Swagger format, defining what are the inputs and outputs (parameters) of the workflow step, such that a service may be accessed according to the API definition. In such an implementation, the operations in the workflow definition information 416 refer to the corresponding API metadata in the interface definition information 418 to provide a complete structure of a generated workflow (e.g., each sequenced workflow step/operation defined with parameter values in the workflow definition information 416 has a corresponding API, which is defined in the interface definition information 418).

Accordingly, flowchart 300 and workflow designer 214 enable a developer to create workflows. FIGS. 6-9 show views of an exemplary workflow in various phases of development using a workflow designer GUI, according to example embodiments. For example, each of FIGS. 6-9 shows browser window 502 displaying a corresponding view of workflow designer GUI 236 being used to develop a workflow.

For instance, FIG. 6 shows browser window 502 including a workflow step 602 and an add interface 604. Workflow step 602 was selected by a developer to be a first step in a workflow. Add interface 604 (e.g., a button or other GUI control) may be interacted with by the developer to add further workflow steps to the workflow.

As described above, a developer is enabled to select workflow step 602 from a list or library of steps, a template gallery, or elsewhere. A list, library, or gallery may include any number of workflow steps. The workflow steps may be associated with network-based applications mentioned elsewhere herein or otherwise known (e.g., Dropbox™) with local applications mentioned elsewhere herein or otherwise known (e.g., Microsoft® Outlook®), or with a service that provides a sandboxed environment (e.g., Microsoft® Azure Functions). Each workflow step is configured to be plugged into the workflow. Each workflow step is configured with the appropriate logic and/or interface(s) to perform its respective function(s), which may include communicating with a local or remote application or communicating with a sandboxed environment. For instance, a workflow step for transmitting a query to an application (e.g., a search query to a search engine, a database query to a database, a request for data from a social networking application, etc.) may be pre-configured in terms of how to properly transmit and format such a request to the application. As another example, a workflow step for receiving a response to a request may be pre-configured in terms of how to parse the response for desired response data. As yet another example, a workflow step for selecting and associating untrusted code may invoke a sandboxed environment to execute the untrusted code. As such, a developer of a workflow does not need to know how to write program code in a programming language, to interface with complex application interfaces (e.g., application programming interfaces (APIs)), or to understand network communication protocols, as the workflow steps are already set up. When a workflow step is plugged into workflow logic by a developer, the developer configures the inputs to the workflow step (as described below), and the pre-configured workflow step handles any communications with other applications.

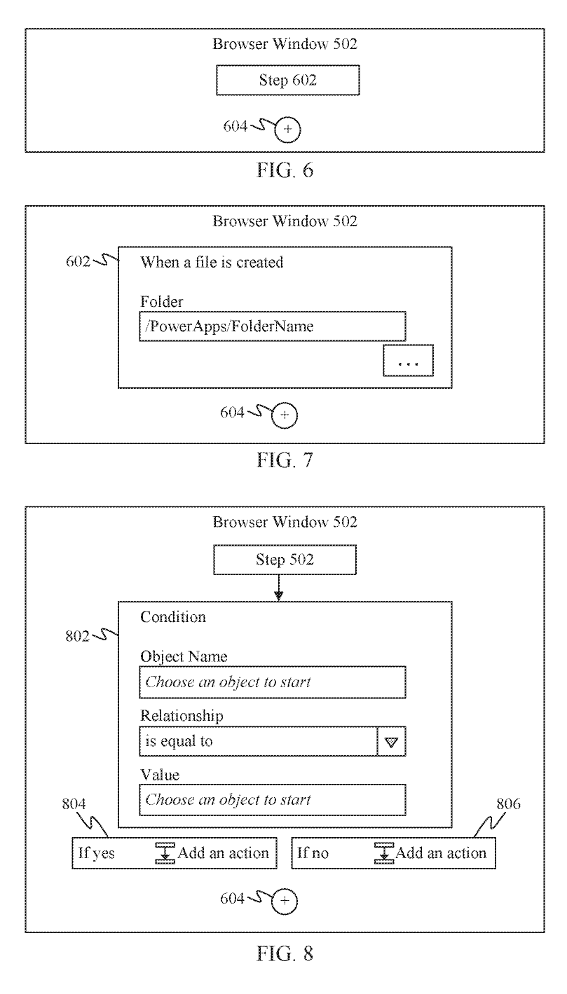

In FIG. 7, the developer has interacted with step 602 (e.g., by mouse click, etc.) to cause step configuration UI generator 408 to generate a UI for configuration of step 602. For instance, in the example of FIG. 7, workflow step 602 is configured to perform monitoring to determine if a file has been created in a particular folder identified by the developer in a text input box (e.g., by typing, clicking on a navigator indicated by “ . . . ”, etc.). When workflow step 602 determines that a file has been added to the indicated folder, a workflow step following workflow step 602 is triggered. Thus, workflow step 602 may be considered a trigger step in this example.

For instance, in FIG. 8, the developer interacted with add interface 604 to facilitate the selection of a next workflow step 802. For instance, in an embodiment, interaction with add interface 602 invokes step selector 406 in FIG. 4, which enables the developer to select a workflow step. In the example of FIG. 8, workflow step 802 is a conditional step. In embodiments, logical elements may be selected for inclusion in a workflow, including arithmetic logic (e.g., summers, multipliers, etc.), conditional logic, etc., that operate based on variable values determined in earlier workflow steps. The condition of workflow step 802 enables the workflow to branch based on the determination of a condition (e.g., a variable value). The condition may include an object name, a relationship (e.g., a logical relationship, such as equal to, includes, not equal to, less than, greater than, etc.), and a value, which are all defined by the developer interacting with workflow step 802. Corresponding action steps may be performed depending on which way the workflow branches based on the condition.

For instance, in one illustrative example of FIG. 8, the object name may be selected (e.g., from a list of possibilities) to be a name of the created file of workflow step 602, the relationship may be “contains” (e.g., selected by a pull-down menu) and the value may be “dummyfile” (e.g., typed in by the developer). The condition evaluates to a “yes” condition if the file name contains “dummyfile,” which invokes first action workflow step 804, and evaluates to “no” condition if the file name does not contain “dummyfile,” which invokes second action workflow step 806. An action may be defined for one or both of the “yes” and “no” action workflow steps 804 and 806 by the developer, if desired.

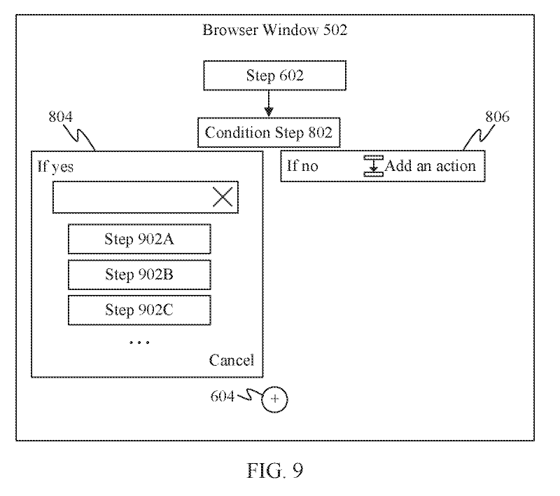

For example, in FIG. 9, the developer interacts with action workflow step 804 to define an action. In this example, the developer is defining action workflow step 804 by selecting a workflow step via step selector 406. As shown in FIG. 9, a list of workflow steps 902A, 902B, 902C is displayed, from which the developer can select a workflow step (e.g., by mouse click, etc.) to be performed for action workflow step 804. The workflow step can be a trigger step, an action step, or a condition step. After selecting the workflow step, the developer may configure the workflow step as described above. Furthermore, the developer may configure an action for workflow step 806, may add further workflow steps, etc., eventually being enabled to save the workflow.

It is noted that in some embodiments, a workflow step, such as first workflow step 602, may require credentials (e.g., a login and password) to access a particular application or data (e.g., to access a file at the location indicated in the text input box in FIG. 7). As such, the developer may be requested to provide credential information in association with first workflow step 602 so that when first workflow step 602 is performed at runtime, the data may be accessed. Alternatively, the credentials may be requested of a user during runtime.

According to embodiments, end users may execute workflows developed as described herein. During operation, an end user may interact with a GUI of the workflow, which may lead to workflow logic being executed. The workflow logic may execute locally (e.g., in a browser) and/or at a remote service (in “the cloud”). The workflow logic may transmit data to or receive data from of one or more local or network-accessible applications or a sandboxed environment. Accordingly, the workflow performs its intended functions.

FIG. 10 is a block diagram of a system 1000 for executing a workflow that includes one or more workflow steps in a runtime environment, according to an example embodiment. As shown in FIG. 10, system 1000 includes a computing device 1002, first network-based application 224, node 208, node 212 and data store(s) 222. Computing device 1002 includes a workflow application 1004. Node 208 includes a workflow execution engine 1018, which is an example of workflow execution engine 118, as shown in FIG. 1. System 1000 is described as follows.

Network-based applications(s) 224 may be optionally present, and whether or not such entities are communicated with will depend on the configuration of workflow logic 220. Further network-based applications and services may be present and communicated with, depending on the configuration of workflow logic 220.

Computing device 1002 may be any type of stationary or mobile computing device described herein or otherwise known. Computing device 1002 is configured to communicate with network-based application(s) 224, node 208 and/or node 212 over network(s) 116.

In one embodiment, workflows are executed at node 208 by workflow execution engine 1018, and workflow application 1004 is a UI application that enables an end user at computing device 1002 to interact with the executing workflows, such as by selecting and invoking the workflows, receiving communications from the executing workflows (e.g., messages, alerts, output data, etc.), providing requested input data to executing workflows, etc. In such an embodiment, workflow application 1004 may be a workflow UI application associated with workflow execution engine 1018 (e.g., workflow application 1004 may be an extension of workflow execution engine 1018) that may operate separately from or within a browser at computing device 1002, or may be configured in another way. As shown in FIG. 10, workflow execution engine 1018 may receive and load workflow logic 220 for a selected workflow (e.g., selected from a workflow library by a user), and may execute workflow logic 220 to execute the workflow.

In another embodiment, workflow application 1004 may be configured to execute workflows at computing device 1002. For instance, an end user of computing device 1002 may interact with a user interface of workflow application 1004 to select and invoke a particular workflow (e.g., selected from a workflow library). In such embodiments, workflow logic 220 may operate separately from or in a browser at computing device 1002, or may be configured in another way. As shown in FIG. 10, workflow application 1004 may load workflow logic 220 for a selected workflow (e.g., selected from a workflow library by a user), and may execute workflow logic 220 to execute the workflow.

In another embodiment, a first portion of workflow logic 220 may execute in workflow application 1004 at computing device 1002 and a second portion of workflow logic 220 may execute in workflow execution engine 1018 at server 208 and/or elsewhere.

During execution of workflow logic 220, sandboxed environment(s) 206 may be invoked (e.g., by workflow execution engine 1018) for workflow step(s) for which pre-compiled untrusted code 248 is associated therewith. When invoked, sandboxed environment(s) 206 may obtain pre-compiled untrusted code 248 and may receive output data 1006 outputted by a previous workflow step to sandboxed environment(s) 206. Sandboxed environment(s) 206 may execute pre-compiled untrusted code 248 using output data 1006 as input data to untrusted code 248. Any output data resulting from the execution of pre-compiled untrusted code 248 may be provided by sandboxed environment(s) 206 as input data 1008 to workflow logic 220. Input data 1008 may be used by workflow logic 220 during execution of subsequent workflow step(s).

FIG. 11 depicts a flowchart 1100 of a process for executing workflow logic 220 of a workflow in a runtime environment, according to an example embodiment. Flowchart 1100 is described as follows with respect to system 1000 of FIG. 10 for illustrative purposes.

Flowchart 1100 begins with step 1102. In step 1102, the workflow is executed. In an embodiment, an end user at computing device 1002 may cause workflow logic 220 to be executed, such as by command line, by clicking/tapping or otherwise interacting with an icon representing the application, by selection in a browser, or in another manner. As described above, workflow logic 220 may execute in workflow application 1004 at computing device 1002 and/or in workflow execution engine 1018 at node 208. When executed, the workflow steps of workflow logic 220 are performed in the configured sequence. Accordingly, one or more of the workflow steps may make calls to corresponding applications/services to perform their functions, such as local application 228 (to send data 232 thereto or obtain data 232 therefrom), network-based application(s) 324 (to send data 230 thereto or obtain data 230 therefrom), sandboxed environment(s) 206 (to send input data 1006 thereto or receive output data 1008 therefrom) and/or other local or network-based applications or services.

In step 1104, the workflow GUI is displayed. Step 1104 is optional, as in some embodiments, a GUI is not displayed for a workflow. In an embodiment, the GUI may be displayed by workflow application 1104 at computing device 1002. When displayed, the end user may interact with the GUI by reviewing displayed data (e.g., from a file, database record, spreadsheet, or other data structure read by the workflow), by entering data into the GUI (e.g., by typing, by voice, etc.), and/or by interacting with one or more controls displayed by the GUI.

In step 1106, workflow logic is triggered based on an interaction with the workflow. Step 1106 is optional in cases where one or more workflow steps of a workflow require input from an end user. In such cases, the end user interacts with a control in a GUI of workflow application 1004 associated with a workflow step of workflow logic 220 to provide information that triggers logic of the workflow step to operate.

In this manner, workflow logic 220 performs its functions, such as processing orders, tracking information, generating messages, processing documents to generate tasks or information, collecting feedback, and/or any other functions.

### B. Example Workflow Development System GUI and Workflow Steps for Associating Untrusted Code Therewith

As discussed in the preceding section, workflow development system 200 enables a user to build a workflow by selectively adding predefined workflow steps to a workflow under development via workflow designer GUI 236. In accordance with an embodiment, a user can utilize workflow development system 200 to select and associate a function comprising untrusted code for a particular workflow step. The custom function is executed in a sandboxed environment, rather than by workflow execution engine 1018. The foregoing may be achieved without requiring the user to be aware that a sandboxed environment is being utilized. Instead, the user simply needs to select and associate a custom function to a particular workflow step, and workflow logic 220 manages the interactions with the sandboxed environment without any further user involvement. Once the steps are included within the workflow under development, the user may configure various parameters (e.g. input parameters) of each workflow step and then save the workflow for subsequent execution.

In further accordance with such an embodiment, a set of predefined steps relating to custom function incorporation are made available to the user for selective inclusion in the workflow (e.g., a “Transform XML” step). For example, step selector 506 of UI generator 210 may cause such steps to be displayed to the user via workflow designer GUI 236 for selection thereby. Also, template gallery generator 402 may display one or more user-selectable workflow templates, wherein each of the templates includes one or more predefined workflow steps that enable a user to associate a custom function that can then be further configured by a user. Still other methods may be used to enable a user to select one or more workflow steps that enable a user to associate to custom function for inclusion within a workflow under development.

Such steps can also be combined with other workflow steps that are designed to interact with other applications (e.g., email applications, document management applications, database applications, social networking applications, financial services applications, news applications, search applications, productivity applications, cloud storage applications, file hosting applications, etc.).

As was previously described, workflow designer 214 generates workflow designer GUI 236 that enables a developer to configure a workflow step within a workflow under development, wherein such configuration includes specifying a value of an input parameter for the workflow step. In an embodiment, workflow designer GUI 236 enables a developer to easily specify a value of an input parameter of a second workflow step to include a value of an output parameter of a first workflow step in the same workflow.

In particular, in accordance with an embodiment, workflow designer GUI 236 represents output parameters of a first workflow step of a workflow under development as user-interactive objects. These objects can be easily interacted with (e.g., clicked on or dragged and dropped) by a developer to cause the objects to be inserted into a data entry element (e.g. a text box) that is used to specify a value for an input parameter of a second workflow step of the workflow under development. When executable logic representing the first and second workflow steps is generated, the aforementioned insertion of the objects into the data entry element has the effect of causing the value of the input parameter of the second workflow step to be defined to include the values of the output parameters that correspond to the inserted objects.

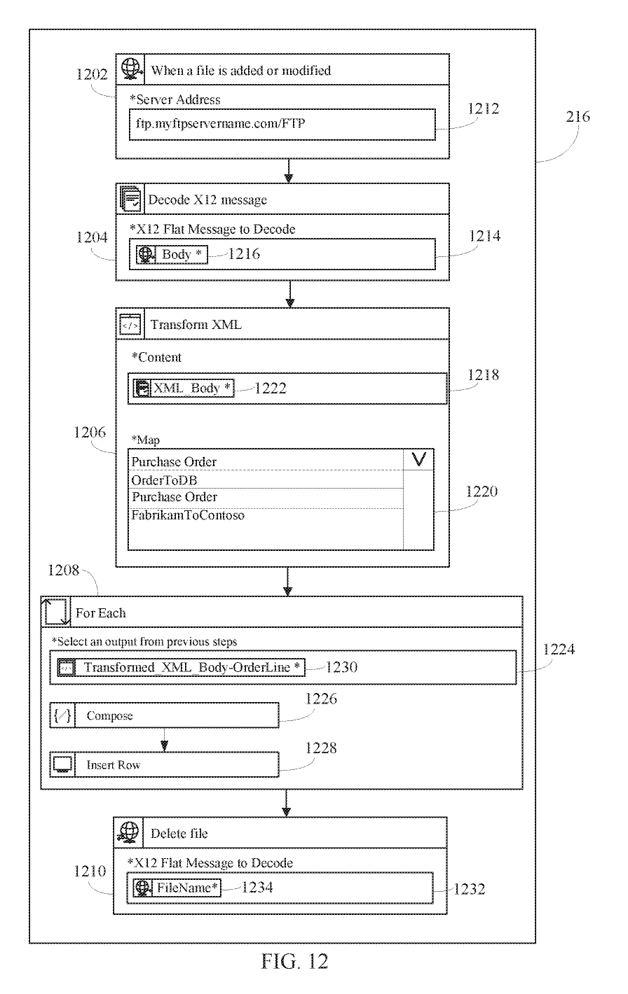

To help illustrate some of the foregoing concepts, FIG. 12 depicts an example GUI screen of a workflow development system that can be used to create a workflow that analyzes a purchase order received from a customer using a function comprising untrusted code and updates a database with information ascertained from the purchase order, in accordance with an embodiment. The GUI screen may be generated, for example, by UI generator 210 of workflow designer 214 as previously described in reference to workflow development system 200 of FIG. 2.

In particular, as shown in FIG. 12, the workflow includes a first workflow step 1202, entitled “When a file is added or modified,” a second workflow step 1204, entitled “Decode X12 message,” a third workflow step 1206, entitled “Transform XML” step, a fourth workflow step 1208, entitled “For Each,” and a fifth workflow step 1210, entitled “Delete file.” Each of first workflow step 1202, second workflow step 1204, third workflow step 1206, fourth workflow step 1208 and fifth workflow step 1210 may be configured to receive one or more user-customizable parameters that may be manually customized by the user. First workflow step 1202 is a trigger step, since it is activated at runtime by the occurrence of a triggering event. In this case, first workflow step 1202 is activated whenever a file is added to a specified FTP server location or when a file stored at the specified location is modified. First workflow step 1202 includes a data entry box 1212, which is configured to receive user-customizable parameters. Data entry box 1212 is configured to receive a user-customizable parameter that specifies a FTP server location (e.g., a uniform resource locator (URL)). As shown in FIG. 12, the user has specified (e.g., entered in) “ftp.myftpservername.com/FTP” as the FTP server location.

Second workflow step 1204, third workflow step 1206, fourth workflow step 1208 and fifth workflow step 1210 are action steps, since they cause an action to be performed at runtime in response to the execution of the trigger step. In this case, the action in second workflow step 1204 is converting the body (i.e., the contents) of the file that was added to (or modified at) the location specified in data entry box 1212 of first workflow step 1202 from an X12 format to an XML format. As shown in FIG. 12, second workflow step 1204 includes a data entry box 1214 that is configured to receive a user-customizable parameter that represents the body of the file located at the location specified in data entry box 1212. As shown in FIG. 12 a user-interactive object 1216 is provided as an input parameter in data entry box 1214. User-interactive object 1216 is an output parameter provided by first workflow step 1202 that represents the body of the file located at the location specified in data entry box 1212.

Third workflow step 1206 is configured to perform an XLST-based transformation on the XML output provided by second workflow step 1204. As shown in FIG. 12, third workflow step 1206 includes a data entry box 1218 and a pull-down menu 1220. Data entry box 1218 is configured to receive a user-customizable parameter that identifies the XML output of second workflow step 1206. As shown in FIG. 12, a user-interactive object 1222 is provided as an input parameter in data entry box 1218. User-interactive object 1222 is an output parameter provided by second workflow step 1204 that represents the XML-converted body of the file located at the location specified in data entry box 1212. Pull-down menu 1220 enables a user to select a function comprising untrusted code to be executed on the XML-converted body. A user may be enabled to select the function from any number of functions. Each of the functions may be pre-compiled and stored in data store(s) 222. In the example shown in FIG. 12, a user has selected the XLST transformation called “Purchase Order.” The “Purchase Order” transformation may be configured to transform the XML-converted body into a format suitable for processing by subsequent workflow steps. For example, the “Purchase Order” transformation may generate a representation of the XML-converted body that defines the elements included therein in accordance with XML Path Language (XPath) syntax. During runtime of the workflow, the XML-converted data (e.g., data 1006, as shown in FIG. 10) is provided to the sandboxed environment (e.g., sandboxed environment(s) 206, as shown in FIG. 10), and the sandboxed environment executes the “Purchase Order” transformation on the XML-converted data to provide transformed XML data. The sandboxed environment provides the transformed XML data (e.g., data 1008, as shown in FIG. 1) to workflow logic 220.

Fourth workflow step 1208 is configured to loop over a specified element of the transformed XML data provided by third workflow step 1206. As shown in FIG. 12, fourth workflow step 1208 includes a data entry box 1224 and two sub-steps: a compose step 1226 and an insert row step 1228. Data entry box 1224 is configured to receive a user-customizable parameter that identifies a particular element of the transformed XML output of third workflow step 1206. As shown in FIG. 12, a user-interactive object 1230 is provided as an input parameter in data entry box 1224. User-interactive object 1230 is an output parameter provided by third workflow step 1206 that represents element “OrderLine” of the transformed XML output.

During runtime of the workflow, for each “OrderLine” element of the transformed XML output, Compose step 1226 is configured to construct a JSON objection from the “OrderLine” element being processed, and Insert Row step 1228 is configured to insert a row in a database table using the JSON object constructed by Compose step 1226 that represents the information specified by the “OrderLine” element.

Fifth workflow step 1210 is configured to delete the file located at the location specified in data entry box 1212 during runtime of the workflow. As shown in FIG. 12, fifth workflow step 1212 includes a data entry box 1232. Data entry box 1232 is configured to receive a user-customizable parameter that identifies the file to be deleted. As shown in FIG. 12 a user-interactive object 1234 is provided as an input parameter in data entry box 1232. User-interactive object 1234 is an output parameter provided by first workflow step 1202 that represents name of the file located at location specified in data entry box 1212.

### C. Example Methods for Development and Execution of a Workflow Including Untrusted Code

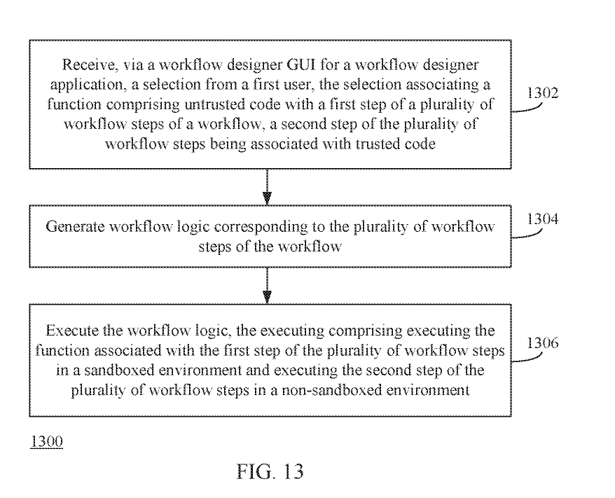

An method of developing and executing a workflow that includes workflow step(s) that comprise untrusted code will now be described. For example, FIG. 13 depicts a flowchart 1300 of a method for developing and executing workflow step(s) that comprise untrusted code in accordance with an embodiment. The method of flowchart 1300 may be performed, for example, by workflow development system 200 and system 1000 as described above.

As shown in FIG. 13, the method of flowchart 1300 starts at step 1302, in which a selection is received from a first user, via a workflow designer graphical user interface (GUI) for a workflow designer application, the selection associating a function comprising untrusted code with a first step of a plurality of workflow steps of a workflow. A second step of the plurality of workflow steps is associated with trusted code. For example, with reference to FIG. 2, workflow designer GUI 236 receives a selection from a first user. The selection associates a function comprising untrusted code with a first step of a plurality of workflow steps of a workflow. As shown in FIG. 12, a user associates a function comprising untrusted code (e.g., the “Purchase Order” map) to third workflow step 1206. First workflow steps 1202, 1204, 1208 and 1210 may be examples of workflow steps that are associated with trusted code.

At step 1304, workflow logic corresponding to the plurality of workflow steps of the workflow is generated. For instance, with reference to FIG. 2, workflow logic generator 240 generates workflow logic corresponding to the plurality of workflow steps of the workflow.

At step 1306, the workflow logic is executed. The execution of the workflow logic comprises executing the function associated with the first step of the plurality of workflow steps in a sandboxed environment and executing the second step of the plurality of workflow steps in a non-sandboxed environment. For example, with reference to FIG. 10, workflow execution engine 1018 is executed in a non-sandboxed environment by workflow execution engine 1018 and the function is executed in sandboxed environment(s) 206.

In accordance with one or more embodiments, the function is received from the first user or a second user, pre-compiled and stored in a data store and executing the function comprises executing the pre-compiled function associated with the first step of the plurality of workflow steps in the sandboxed environment. For example, with reference to FIG. 2, sandboxed environment(s) 206 may pre-compile untrusted code 246 to generate pre-compiled untrusted code 248 and store pre-compiled untrusted code 248 in data store(s) 222. With reference to FIG. 10, sandboxed environment(s) 206 may execute pre-compiled untrusted code 248 during execution of the workflow.

In accordance with one or more embodiments, the sandboxed environment is configured to limit one or more computing resources that are to be utilized during execution of the function.

In accordance with one or more embodiments, the function is coded by an entity other than the publisher of the workflow designer application.

In accordance with one or more embodiments, when executing the function associated with the first step of the plurality of workflow steps in the sandboxed environment, a first output from executable workflow logic corresponding to a workflow step preceding the first step is provided as an input to the sandboxed environment. The function is executed in the sandboxed environment using the input to generate a second output. The second output is received from the sandboxed environment and provided to executable workflow logic corresponding to a workflow step subsequent to the first step for utilization thereby. For example, with reference to FIG. 13, workflow logic 220 may provide output data 1006 to sandboxed environment(s) 206, which uses output data 1006 as input data when executing pre-compiled untrusted code 248. Sandboxed environment(s) 206 may generate output data as a result of the execution of pre-compiled untrusted code 248 and provide the output data as input data 1008 to workflow logic 220. Workflow logic 220 may use input data 1008 during execution of subsequent workflow step(s).

In accordance with one or more embodiments, the workflow logic is executed on a first virtual machine, and the function is executed in the sandboxed environment on a second virtual machine that is different that the first virtual machine.

In accordance with one or more embodiments, the first virtual machine is a multi-tenant virtual machine.

In accordance with one or more embodiments, the second virtual machine is a multi-tenant virtual machine.

### III. Example Mobile and Stationary Device Embodiments

The systems described above, including the workflow development and execution systems described in reference to FIGS. 1-13, may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

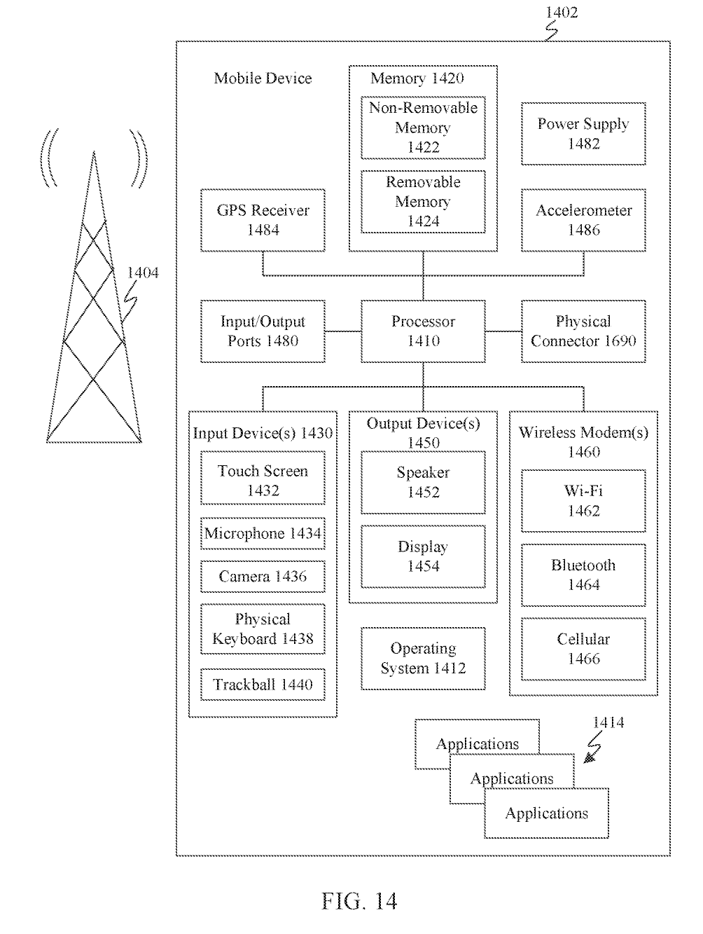

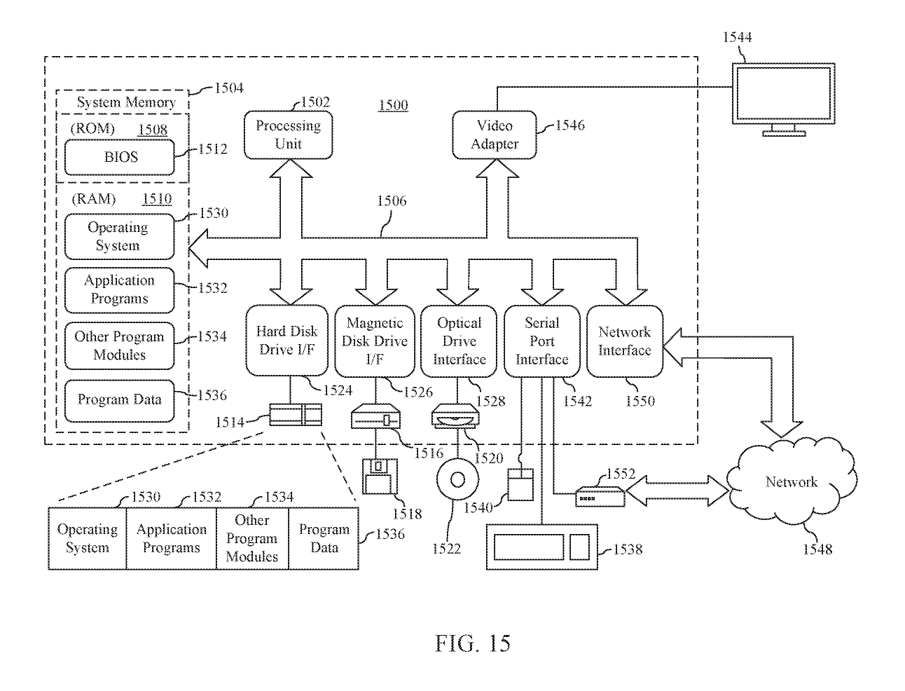

FIG. 14 shows a block diagram of an exemplary mobile device 1400 including a variety of optional hardware and software components, shown generally as components 1402. Any number and combination of the features/elements of components 1402 may be included in a mobile device embodiment, as well as additional and/or alternative features/elements, as would be known to persons skilled in the relevant art(s). It is noted that any of components 1402 can communicate with any other of components 1402, although not all connections are shown, for ease of illustration. Mobile device 1400 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 1404, such as a cellular or satellite network, or with a local area or wide area network.

The illustrated mobile device 1400 can include a controller or processor referred to as processor circuit 1410 for performing such tasks as signal coding, image processing, data processing, input/output processing, power control, and/or other functions. Processor circuit 1410 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1410 may execute program code stored in a computer readable medium, such as program code of one or more applications 1414, operating system 1412, any program code stored in memory 1420, etc. Operating system 1412 can control the allocation and usage of the components 1402 and support for one or more application programs 1414 (a.k.a. applications, “apps”, etc.). Application programs 1414 can include common mobile computing applications (e.g., email applications, calendars, contact managers, web browsers, messaging applications) and any other computing applications (e.g., word processing applications, mapping applications, media player applications).

As illustrated, mobile device 1400 can include memory 1420. Memory 1420 can include non-removable memory 1422 and/or removable memory 1424. The non-removable memory 1422 can include RAM, ROM, flash memory, a hard disk, or other well-known memory storage technologies. The removable memory 1424 can include flash memory or a Subscriber Identity Module (SIM) card, which is well known in GSM communication systems, or other well-known memory storage technologies, such as “smart cards.” The memory 1420 can be used for storing data and/or code for running the operating system 1412 and the applications 1414. Example data can include web pages, text, images, sound files, video data, or other data sets to be sent to and/or received from one or more network servers or other devices via one or more wired or wireless networks. Memory 1420 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 1420. These programs include operating system 1412, one or more application programs 1414, and other program modules and program data. Examples of such application programs or program modules may include, for example, computer program logic (e.g., computer program code or instructions) for implementing the systems described above, including the workflow development and execution systems described in reference to FIGS. 1-13.

Mobile device 1400 can support one or more input devices 1430, such as a touch screen 1432, microphone 1434, camera 1436, physical keyboard 1438 and/or trackball 1440 and one or more output devices 1450, such as a speaker 1452 and a display 1454.

Other possible output devices (not shown) can include piezoelectric or other haptic output devices. Some devices can serve more than one input/output function. For example, touch screen 1432 and display 1454 can be combined in a single input/output device. The input devices 1430 can include a Natural User Interface (NUI).

Wireless modem(s) 1460 can be coupled to antenna(s) (not shown) and can support two-way communications between processor circuit 2110 and external devices, as is well understood in the art. The modem(s) 1460 are shown generically and can include a cellular modem 1466 for communicating with the mobile communication network 1404 and/or other radio-based modems (e.g., Bluetooth 1464 and/or Wi-Fi 1462). Cellular modem 1466 may be configured to enable phone calls (and optionally transmit data) according to any suitable communication standard or technology, such as GSM, 3G, 4G, 5G, etc. At least one of the wireless modem(s) 1460 is typically configured for communication with one or more cellular networks, such as a GSM network for data and voice communications within a single cellular network, between cellular networks, or between the mobile device and a public switched telephone network (PSTN).

Mobile device 1400 can further include at least one input/output port 1480, a power supply 1482, a satellite navigation system receiver 1484, such as a Global Positioning System (GPS) receiver, an accelerometer 1486, and/or a physical connector 1490, which can be a USB port, IEEE 1394 (FireWire) port, and/or RS-232 port. The illustrated components 1402 are not required or all-inclusive, as any components can be not present and other components can be additionally present as would be recognized by one skilled in the art.

Furthermore, FIG. 15 depicts an exemplary implementation of a computing device 1500 in which embodiments may be implemented. The description of computing device 1500 provided herein is provided for purposes of illustration, and is not intended to be limiting. Embodiments may be implemented in further types of computer systems, as would be known to persons skilled in the relevant art(s).

As shown in FIG. 15, computing device 1500 includes one or more processors, referred to as processor circuit 1502, a system memory 1504, and a bus 1506 that couples various system components including system memory 1504 to processor circuit 1502. Processor circuit 1502 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1502 may execute program code stored in a computer readable medium, such as program code of operating system 1530, application programs 1532, other programs 1534, etc. Bus 1506 represents one or more of any of several types of bus structures, including a memory bus or memory controller, a peripheral bus, an accelerated graphics port, and a processor or local bus using any of a variety of bus architectures. System memory 1504 includes read only memory (ROM) 1508 and random access memory (RAM) 1510. A basic input/output system 1512 (BIOS) is stored in ROM 1508.

Computing device 1500 also has one or more of the following drives: a hard disk drive 1514 for reading from and writing to a hard disk, a magnetic disk drive 1516 for reading from or writing to a removable magnetic disk 1518, and an optical disk drive 1520 for reading from or writing to a removable optical disk 1522 such as a CD ROM, DVD ROM, or other optical media. Hard disk drive 1514, magnetic disk drive 1516, and optical disk drive 1520 are connected to bus 1506 by a hard disk drive interface 1524, a magnetic disk drive interface 1526, and an optical drive interface 1528, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1530, one or more application programs 2532, other programs 1534, and program data 1536. Application programs 1532 or other programs 1534 may include, for example, computer program logic (e.g., computer program code or instructions) for implementing the systems described above, including the workflow development and execution systems described in reference to FIGS. 1-13.

A user may enter commands and information into the computing device 1500 through input devices such as keyboard 1538 and pointing device 1540. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1502 through a serial port interface 1542 that is coupled to bus 1506, but may be connected by other interfaces, such as a parallel port, game port, or a universal serial bus (USB).

A display screen 1544 is also connected to bus 1506 via an interface, such as a video adapter 1546. Display screen 1544 may be external to, or incorporated in computing device 1500. Display screen 1544 may display information, as well as being a user interface for receiving user commands and/or other information (e.g., by touch, finger gestures, virtual keyboard, etc.). In addition to display screen 1544, computing device 1500 may include other peripheral output devices (not shown) such as speakers and printers.

Computing device 1500 is connected to a network 1548 (e.g., the Internet) through an adaptor or network interface 1550, a modem 1552, or other means for establishing communications over the network. Modem 1552, which may be internal or external, may be connected to bus 1506 via serial port interface 1542, as shown in FIG. 15, or may be connected to bus 1506 using another interface type, including a parallel interface.

As used herein, the terms “computer program medium,” “computer-readable medium,” and “computer-readable storage medium” are used to generally refer to physical hardware media such as the hard disk associated with hard disk drive 1514, removable magnetic disk 1518, removable optical disk 1522, other physical hardware media such as RAMs, ROMs, flash memory cards, digital video disks, zip disks, MEMs, nanotechnology-based storage devices, and further types of physical/tangible hardware storage media (including system memory 1504 of FIG. 15). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 1532 and other programs 1534) may be stored on the hard disk, magnetic disk, optical disk, ROM, RAM, or other hardware storage medium. Such computer programs may also be received via network interface 1550, serial port interface 1552, or any other interface type. Such computer programs, when executed or loaded by an application, enable computing device 1500 to implement features of embodiments discussed herein. Accordingly, such computer programs represent controllers of the computing device 1500.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Exemplary Embodiments

A computer-implemented method for developing and executing a workflow is described herein. The method includes: receiving, via a workflow designer GUI for a workflow designer application, a selection from a first user, the selection associating a function comprising untrusted code with a first step of a plurality of workflow steps of a workflow, a second step of the plurality of workflow steps being associated with trusted code; generating workflow logic corresponding to the plurality of workflow steps of the workflow; and executing the workflow logic, the executing comprising executing the function associated with the first step of the plurality of workflow steps in a sandboxed environment and executing the second step of the plurality of workflow steps in a non-sandboxed environment.

In one embodiment of the foregoing method, the function is received from the first user or a second user, pre-compiled and stored in a data store; and said executing comprises executing the pre-compiled function associated with the first step of the plurality of workflow steps in the sandboxed environment.

In another embodiment of the foregoing method, the sandboxed environment is configured to limit one or more computing resources that are to be utilized during execution of the function.

In a further embodiment of the foregoing method, the function is coded by an entity other than the publisher of the workflow designer application.

In yet another embodiment of the foregoing method, said executing the function associated with the first step of the plurality of workflow steps in the sandboxed environment comprises: providing a first output from executable workflow logic corresponding to a workflow step preceding the first step of the plurality of workflow steps as an input to the sandboxed environment; executing the function in the sandboxed environment using the input to generate a second output; and receiving, from the sandboxed environment, the second output and providing the second output to executable workflow logic corresponding to a workflow step of the workflow subsequent to the first step of the plurality of workflow steps for utilization thereby.

In still another embodiment of the foregoing method, the workflow logic is executed on a first virtual machine, and the function is executed in the sandboxed environment on a second virtual machine that is different that the first virtual machine.

In another embodiment of the foregoing method, the first virtual machine is a multi-tenant virtual machine.

In yet another embodiment of the foregoing method, the second virtual machine is a multi-tenant virtual machine.

A system is described. The system comprises: one or more first servers configured to execute: a workflow designer application configured to: receive, via a workflow designer graphical user interface (GUI), a selection from a first user, the selection associating a function comprising untrusted code with a first step of a plurality of workflow steps of a workflow, a second step of the plurality of workflow steps being associated with trusted code; and generate workflow logic corresponding to the plurality of workflow steps of the workflow; and a workflow execution engine configured to execute the workflow logic and configured to execute the second step of the plurality of workflow steps in a non-sandboxed environment; and one or more second servers configured to execute the function associated with the first step of the plurality of workflow steps in a sandboxed environment.

In one embodiment of the foregoing system, the function is received from the first user or a second user, pre-compiled and stored in a data store; and the one or more second servers are configured to retrieve the pre-compiled function associated with the first step of the plurality of workflow steps from the data store and execute the pre-compiled function in the sandboxed environment.

In another embodiment of the foregoing system, the sandboxed environment is configured to limit one or more computing resources that are to be utilized during execution of the function.

In yet another embodiment of the foregoing system, the function is coded by an entity other than the publisher of the workflow designer application.

In still another embodiment of the foregoing system, the one or more second servers are configured to execute the function associated with the first step of the plurality of workflow steps in the sandboxed environment by: receiving a first output from executable workflow logic corresponding to a workflow step preceding the first step of the plurality of workflow steps as an input; executing the function in the sandboxed environment using the input to generate a second output; and providing the second output to the one or more first servers, the workflow execution engine being configured to provide the second output to executable workflow logic corresponding to a workflow step subsequent to the first step of the plurality of workflow steps for utilization thereby.

A computer-readable storage medium having program instructions recorded thereon that, when executed by at least one processing circuit, perform a method, the method comprising: receiving, via a server, executable workflow logic corresponding to each of a plurality of workflow steps of a workflow, the executable workflow logic being generated by a workflow designer application that enables a first user to associate a function comprising untrusted code with a first step of the plurality of workflow steps via a graphical user interface (GUI) for the workflow designer application, a second step of the plurality of workflow steps being associated with trusted code; and executing, via the server, the workflow logic, the executing comprising causing the function associated with the first step of the plurality of workflow steps to be executed in a sandboxed environment and executing the second step of the plurality of workflow steps in a non-sandboxed environment.

In one embodiment of the foregoing computer-readable storage medium, the function is received from the first user or a second user, pre-compiled and stored in a data store; and said executing comprises causing the pre-compiled function associated with the first step of the plurality of workflow steps to be executed in the sandboxed environment.

In another embodiment of the foregoing method, the sandboxed environment is configured to limit one or more computing resources that are to be utilized during execution of the function.

In a further embodiment of the foregoing computer-readable storage medium, the function is coded by an entity other than the publisher of the workflow designer application.

In yet another embodiment of the foregoing computer-readable storage medium, said executing comprises: providing, via the first virtual machine, a first output from executable workflow logic corresponding to a workflow step preceding the first step of the plurality of workflow steps as an input to the sandboxed environment, the sandboxed environment being configured to execute the function using the input to generate a second output; and receiving, via the first virtual machine, the second output and providing the second output to executable workflow logic corresponding to a workflow step subsequent to the first step of the plurality of workflow steps for utilization thereby.

In still another embodiment of the foregoing computer-readable storage medium, said receiving and executing are performed by a virtual machine executing on the server.

In another embodiment of the foregoing computer-readable storage medium, the virtual machine is a multi-tenant virtual machine.

### V Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A computer-implemented method for developing and executing a workflow, comprising:
receiving, via a workflow designer graphical user interface (GUI) for a workflow designer application, a selection from a first user, the selection associating a function comprising untrusted code with a first step of a plurality of workflow steps of a workflow, a second step of the plurality of workflow steps being associated with trusted code;
generating workflow logic corresponding to the plurality of workflow steps of the workflow; and
executing the workflow logic, the executing comprising executing the function associated with the first step of the plurality of workflow steps in a sandboxed environment and executing the second step of the plurality of workflow steps in a non-sandboxed environment.

2. The computer-implemented method of claim 1, wherein the function is received from the first user or a second user, pre-compiled and stored in a data store; and
wherein said executing comprises executing the pre-compiled function associated with the first step of the plurality of workflow steps in the sandboxed environment.

3. The computer-implemented method of claim 1, wherein the sandboxed environment is configured to limit one or more computing resources that are to be utilized during execution of the function.

4. The computer-implemented method of claim 1, wherein the function is coded by an entity other than the publisher of the workflow designer application.

5. The computer-implemented method of claim 1, wherein said executing the function associated with the first step of the plurality of workflow steps in the sandboxed environment comprises:
providing a first output from executable workflow logic corresponding to a workflow step preceding the first step of the plurality of workflow steps as an input to the sandboxed environment;
executing the function in the sandboxed environment using the input to generate a second output; and
receiving, from the sandboxed environment, the second output and providing the second output to executable workflow logic corresponding to a workflow step of the workflow subsequent to the first step of the plurality of workflow steps for utilization thereby.

6. The computer-implemented method of claim 1, wherein the workflow logic is executed on a first virtual machine, and the function is executed in the sandboxed environment on a second virtual machine that is different that the first virtual machine.

7. The computer-implemented method of claim 6, wherein the first virtual machine is a multi-tenant virtual machine.

8. The computer-implemented method of claim 6, wherein the second virtual machine is a multi-tenant virtual machine.

9. A system, comprising:
one or more first servers configured to execute:
a workflow designer application configured to:
receive, via a workflow designer graphical user interface (GUI), a selection from a first user, the selection associating a function comprising untrusted code with a first step of a plurality of workflow steps of a workflow, a second step of the plurality of workflow steps being associated with trusted code; and
generate workflow logic corresponding to the plurality of workflow steps of the workflow; and
a workflow execution engine configured to execute the workflow logic and configured to execute the second step of the plurality of workflow steps in a non-sandboxed environment; and
one or more second servers configured to execute the function associated with the first step of the plurality of workflow steps in a sandboxed environment.

10. The system of claim 9, wherein the function is received from the first user or a second user, pre-compiled and stored in a data store; and
wherein the one or more second servers are configured to retrieve the pre-compiled function associated with the first step of the plurality of workflow steps from the data store and execute the pre-compiled function in the sandboxed environment.

11. The system of claim 9, wherein the sandboxed environment is configured to limit one or more computing resources that are to be utilized during execution of the function.

12. The system of claim 9, wherein the function is coded by an entity other than the publisher of the workflow designer application.

13. The system of claim 9, wherein the one or more second servers are configured to execute the function associated with the first step of the plurality of workflow steps in the sandboxed environment by:
receiving a first output from executable workflow logic corresponding to a workflow step preceding the first step of the plurality of workflow steps as an input;
executing the function in the sandboxed environment using the input to generate a second output; and
providing the second output to the one or more first servers, the workflow execution engine being configured to provide the second output to executable workflow logic corresponding to a workflow step subsequent to the first step of the plurality of workflow steps for utilization thereby.

14. A computer-readable storage medium having program instructions recorded thereon that, when executed by at least one processing circuit, perform a method, the method comprising:
receiving, via a server, executable workflow logic corresponding to each of a plurality of workflow steps of a workflow, the executable workflow logic being generated by a workflow designer application that enables a first user to associate a function comprising untrusted code with a first step of the plurality of workflow steps via a graphical user interface (GUI) for the workflow designer application, a second step of the plurality of workflow steps being associated with trusted code; and
executing, via the server, the workflow logic, the executing comprising causing the function associated with the first step of the plurality of workflow steps to be executed in a sandboxed environment and executing the second step of the plurality of workflow steps in a non-sandboxed environment.

15. The computer-readable storage medium of claim 14, wherein the function is received from the first user or a second user, pre-compiled and stored in a data store; and
wherein said executing comprises causing the pre-compiled function associated with the first step of the plurality of workflow steps to be executed in the sandboxed environment.

16. The computer-readable storage medium of claim 14, wherein the sandboxed environment is configured to limit one or more computing resources that are to be utilized during execution of the function.

17. The computer-readable storage medium of claim 14, wherein the function is coded by an entity other than the publisher of the workflow designer application.

18. The computer-readable storage medium of claim 14, wherein said executing comprises:
providing, via the first virtual machine, a first output from executable workflow logic corresponding to a workflow step preceding the first step of the plurality of workflow steps as an input to the sandboxed environment, the sandboxed environment being configured to execute the function using the input to generate a second output; and
receiving, via the first virtual machine, the second output and providing the second output to executable workflow logic corresponding to a workflow step subsequent to the first step of the plurality of workflow steps for utilization thereby.

19. The computer-readable storage medium of claim 14, wherein said receiving and executing are performed by a virtual machine executing on the server.

20. The computer-readable storage medium of claim 19, wherein the virtual machine is a multi-tenant virtual machine.
